(19) United States
(12) Patent Application Publication
(10) Pub. No.: US 2013/0075455 A1
(43) Pub. Date: Mar. 28, 2013

(54) REFLOW PRETREATMENT APPARATUS AND REFLOW PRETREATMENT METHOD

(71) Applicant: Yuji SHIMIZU, Kanagawa (JP)

(72) Inventor: Yuji SHIMIZU, Kanagawa (JP)

(73) Assignee: Renesas Electronics Corporation, Kanagawa (JP)

(21) Appl. No.: 13/555,041

(22) Filed: Jul. 20, 2012

(30) Foreign Application Priority Data
Sep. 28, 2011 (JP) 2011-211907

(51) Int. Cl. B23K 31/02; B23K 3/08

(52) U.S. Cl. 228/256; 228/18

(57) ABSTRACT

This invention is to prevent tin from being adhered to a surface of part of an object to be soldered, a solder bump being formed in the part thereof. A reflow pretreatment apparatus includes a hydrogen radical generator and a filter for capturing suspended solids. The hydrogen radical generator radiates hydrogen radicals onto solder arranged in an object to be soldered. The filter for capturing suspended solids is arranged such that the hydrogen radicals are radiated onto the solder after passing through the filter for capturing suspended solids.

### CROSS-REFERENCE TO RELATED APPLICATIONS

The disclosure of Japanese Patent Application No. 2011-211907 filed on Sep. 28, 2011 including the specification, drawings and abstract is incorporated herein by reference in its entirety.

### BACKGROUND

The present invention relates to a reflow pretreatment apparatus and a reflow pretreatment method, and in particular, to a reflow pretreatment apparatus and a reflow pretreatment method, which are used when a solder bump is formed.

Solder bumps, formed over a semiconductor chip when flip-chip implementation (FC coupling: Flip-Chip coupling) is performed, are known. The solder bumps are formed by subjecting the solder arranged over the semiconductor chip to a heat treatment (reflow treatment) in a low oxygen atmosphere. The solder bumps are mechanically and electrically coupled to electrode pads formed over the semiconductor chip.

Methods of arranging solder over a semiconductor chip are exemplified by a plating method, printing method, solder ball mounting method, etc. The solder is exemplified by an alloy in which components, such as tin Sn, are added to lead Pb that is a principal component, or an alloy in which silver Ag and copper Cu are added to tin Sn that is a principal component. In such solder, if a reflow treatment is performed in a state where an oxide film is directly formed on the surface thereof, there are sometimes the cases where the oxide film inhibits melting of the solder, and thereby not allowing the solder to be formed into a bump shape that is required for the subsequent FC coupling. Accordingly, in the reflow treatment, it is needed to remove the oxide film before or during the heat treatment of the solder.

Methods of removing an oxide film are exemplified by a method using a reduction reaction by flux, and a method of removing an oxide film by a reaction with a reducing gas. The reducing gas is exemplified by formic acid, hydrogen, or the like. In a treatment using formic acid, it is known that, as the pitch between the electrode pads over a semiconductor chip is smaller, it becomes more difficult that the formic acid enters the gap between the solders. In a treatment by polar hydrogen plasma, it is known that the charge of a semiconductor chip becomes an issue. In a method of removing an oxide film on the surface of a bump by using the hydrogen gas, the oxide film on the surface thereof is removed by ionizing and radicalizing the hydrogen gas to be radiated onto the surface of the bump in a state of reactivity being high.

Japanese Unexamined Patent Publication No. 2001-058259 discloses a soldering method in which a cleaning step is not required. The soldering method includes the steps of: reducing the pressure in a vacuum chamber, in which an object to be treated having solder is placed, to a vacuum state; heating the temperature in the vacuum chamber in the vacuum state to the melting temperature of the solder and keeping at the melting temperature thereof; and supplying hydrogen radicals into the vacuum chamber concurrently with the heating step. In the soldering method, hydrogen ions and hydrogen radicals are generated by irradiating hydrogen gas with microwaves. By installing, under a plasma generator, a grounded metallic filter for capturing ions, electrically-neutral hydrogen radicals, among the hydrogen ions and hydrogen radicals, only pass through the filter and are radiated onto the surface of a wafer. According to such radiation, it can be suppressed that the wafer may be charged. Solder is melted by performing a heat treatment at a temperature higher than or equal to the melting temperature of the solder in a vacuum or inert gas atmosphere after an oxide film on the surface of the solder has been removed, so that a solder bump is formed.

Japanese Unexamined Patent Publication No. 2007-053245 discloses a soldering method in which a crease is prevented from occurring on the surface of a solder. The soldering method includes the steps of: radiating a free radical gas onto a solder and an object to be treated having a portion to which the solder is to be joined at a temperature lower than the melting temperature of the solder and a pressure lower than the atmospheric pressure; following the step above, heating the object to be treated to a temperature higher than or equal to the melting temperature of the solder in a reducing atmosphere or inert atmosphere at or around the atmospheric pressure; and following the step above, cooling the object to be treated in a reducing or inert atmosphere at or around the atmospheric pressure.

Japanese Unexamined Patent Publication No. 2005-230830 discloses a soldering method with good quality. In the soldering method, the pressure in a vacuum chamber in which an object to be treated having solid solder including: tin alone; or tin and one or more components selected from the group of silver, lead, copper, bismuth, indium and zinc, is placed is reduced to a vacuum state, followed by removal of an oxide film on the solder by generating a free radical gas, and the generation of the free radical gas is then stopped such that the solder is melted by heating the solder to a temperature higher than or equal to the melting temperature of the solder in a non-oxidation atmosphere.

### SUMMARY

An oxide film directly formed on the surface of solder includes a tin oxide film. When irradiated with activated hydrogen exemplified by a hydrogen ion, a hydrogen radical, or the like, the tin oxide film generates tin hydride SnH₄ by a reaction represented by the following chemical equation: SnO₂+4H*→Sn+2H₂OSnO₂+8H*→*SnH₄+2H₂O. Tin hydride SnH₄ is a gas and floats in a treatment chamber after being generated. When reaching a protective film (e.g., formed of polyimide) directly formed on the surface of a wafer, the floating tin hydride SnH₄ is degraded into tin Sn and hydrogen H₂ with the protective film serving as a catalyst, thereby sometimes causing the tin Sn to be adhered to the protective film. The adhesion of such tin sometimes causes a problem.

An object of the present invention is to provide a reflow pretreatment apparatus and a reflow pretreatment method, in which it is prevented that tin may be adhered to the surface of part of an object to be soldered, a solder bump being formed in the part thereof.

Reference numerals used in the embodiments and examples for carrying out the present invention will be denoted with parentheses, and means for solving the problems will be described. The reference numerals are added in order to clarify the correspondence between the claims and the embodiments and examples for carrying out the invention, and should not be used in construing the technical scopes of the inventions described in the claims.

A reflow pretreatment apparatus according to the present invention includes a hydrogen radical generator (3) and filters for capturing suspended solids (5) and (31). The hydrogen radical generator (3) radiates hydrogen radicals onto solder arranged in an object to be soldered (10). The filters for capturing suspended solids (5) and (31) are arranged such that the hydrogen radicals are radiated onto the solder after passing through the filters for capturing suspended solids (5) and (31).

A reflow pretreatment method according to the present invention includes the steps of: arranging an object to be soldered (10) and filters for capturing suspended solids (5) and (31) at predetermined positions; and irradiating solder arranged in the object t be soldered (10) with hydrogen radials, while the object to be soldered (10) and the filters for capturing suspended solids (5) and (31) are being arranged at the predetermined positions. The hydrogen radicals are radiated onto the solder after passing through the filters for capturing suspended solids (5) and (31), while the object to be soldered (10) and the filters for capturing suspended solids (5) and (31) are being arranged at the predetermined positions.

In the reflow pretreatment apparatus and the reflow pretreatment method according to the present invention, it can be prevented that tin may be adhered to the surface of part of an object to be soldered, solder being arranged in the part thereof.

### BRIEF DESCRIPTION OF THE DRAWINGS

FIG. 1 is a sectional view illustrating a reflow pretreatment apparatus according to the present invention;

FIG. 2 is a sectional view illustrating a cross section taken along A-A line in FIG. 1, in which a filter for capturing tin is illustrated;

FIG. 3 is a sectional view illustrating an FCBGA package manufactured by a method of manufacturing a semiconductor package product, to which the reflow pretreatment method according to the present invention is applied;

FIG. 4 is a plan view illustrating another filter for capturing tin;

FIG. 5 is a sectional view illustrating a comparative example of a reflow pretreatment apparatus;

FIG. 6 is a graph showing amounts of tin accumulating on the surfaces of protective films; and

FIG. 7 is a graph showing the numbers of occurrences of peeing-off of filled resins.

### DETAILED DESCRIPTION

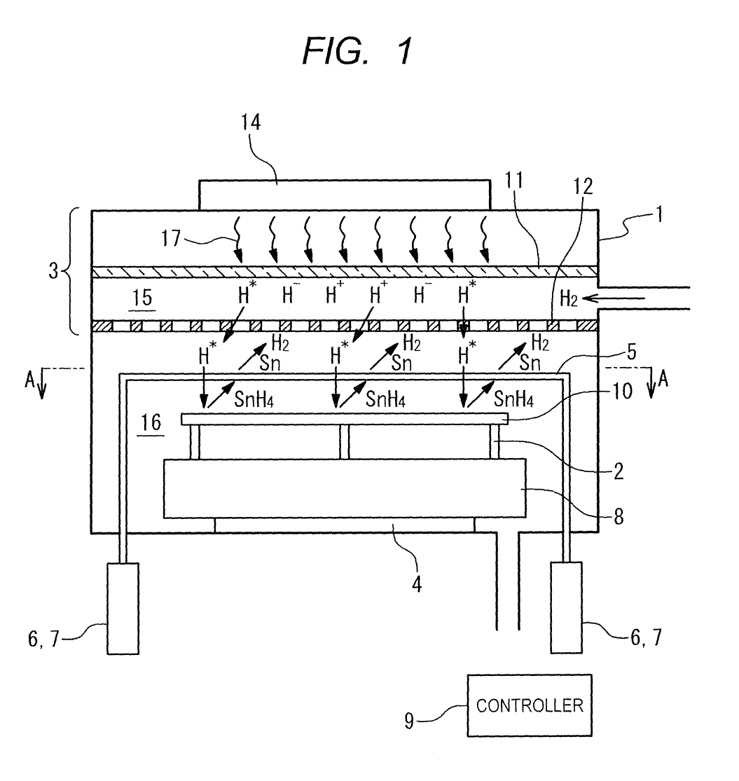

Preferred embodiments of a reflow pretreatment apparatus according to the present invention will be described with reference to the accompanying drawings. As illustrated in FIG. 1, a plurality of devices are provided in a chamber 1 in the reflow pretreatment apparatus. The chamber 1 is a container for isolating the inside thereof from the outside. A gate is provided in the chamber 1. The gate is provided for communicating between the inside of the chamber 1 and that of a load lock chamber, and is closed or opened by a user. The load lock chamber includes a conveyor. When the gate is opened, the conveyor conveys, into the inside of the chamber 1, an object to be conveyed placed inside the load lock chamber, or conveys, into the inside of the load lock chamber, an object to be conveyed placed inside the chamber 1.

The devices include a plurality of lift pins 2, a pin drive device 4, a hydrogen radical generator 3, a filter for capturing tin 5, a filter drive motor 6, a filter heater 7, a wafer heater 8, and a controller 9.

Each of the lift pins 2 is formed into a rod shape and a holding portion is formed at one end thereof. Each of the lift pins 2 is arranged in the chamber 1 such that it is oriented in the vertical direction and the holding portion is pointed toward the upper side in the vertical direction. The lift pins 2 are further supported by the chamber 1 so as to be movable in parallel in the vertical direction such that all of the holding portions of the lift pins 2 are arranged on one horizontal plane. The lift pins 2 hold a wafer 10 in the chamber 1, with the wafer 10 being placed on the holding portions of the lift pins 2.

A plurality of circuit elements and a plurality of wirings are provided inside the wafer 10. The wirings form a plurality of circuits by electrically coupling the circuit elements. A protective film and a plurality of electrode pads are further provided on the surface layer of the wafer 10. The protective film is formed of polyimide and covers the circuit elements and the wirings to protect them from the outside environment. A plurality of openings are formed in the protective film. Each of the electrode pads is formed of a conductor and is arranged in each of the openings. Each of the electrode pads is electrically coupled to one of the circuit elements via each of the wirings. Further, a plurality of solders are respectively arranged in the electrode pads in the wafer 10. Each of the solders is formed of an alloy including tin Sn and lead Pb.

Alternatively, the solder may be replaced by another metal including tin Sn. Examples of such solder include: an alloy including tin Sn and silver Ag; an alloy including tin Sn and copper Cu; and pure tin.

The pin drive device 4 moves, by being controlled by the controller 9, all of the lift pins 2 in parallel in the vertical direction, while all of the holding portions of the lift pins 2 are being arranged on one horizontal plane.

The hydrogen radical generator 3 includes a quartz plate 11, a filter for capturing ions 12, and a magnetron 14. The quartz plate 11 is formed of quartz and formed into a plate shape. The filter for capturing ions 12 is formed of aluminum and formed into a plate-shaped mesh. Alternatively, the filter for capturing ions 12 may be formed of another conductor different from aluminum. An example of such a conductor includes a stainless steel. The filter for capturing ions 12 is arranged in the chamber 1 such that the inside of the chamber 1 is divided into a plasma generating chamber 15 and a reflow pretreatment chamber 16. That is, the filter for capturing ions 12 isolates the plasma generating chamber 15 and the reflow pretreatment chamber 16 from each other. The plasma generating chamber 15 is a space sandwiched by the quartz plate 11 and the filter for capturing ions 12. The lift pins 2 are arranged in the reflow pretreatment chamber 16. The filter for capturing ions 12 is further grounded. The magnetron 14 outputs, by being controlled by the controller 9, a microwave 17 into the plasma generating chamber 15 via the quartz plate 11. The hydrogen radical generator 3 further includes a non-illustrated hydrogen gas feeder. The hydrogen gas feeder supplies, by being controlled by the controller 9, hydrogen gas into the plasma generating chamber 15 via a pipe coupled to the plasma generating chamber 15.

The filter for capturing tin 5 is formed of nickel Ni. The filter for capturing tin 5 is arranged in the chamber 1 and is supported so as to be movable in parallel and rotatably inside the chamber 1. The filter drive motor 6 moves the filter for capturing tin 5 by being controlled by the controller 9. The filter drive motor 6 further measures the position of the filter for capturing tin 5 and outputs the position to the controller 9. The filter heater 7 is thermally coupled to the filter for capturing tin 5. The filter heater 7 generates heat by being controlled by the controller 9. The filter heater 7 further measures the temperature of the filter for capturing tin 5 and outputs the temperature to the controller 9. The wafer heater 8 is arranged in the reflow pretreatment chamber 16 inside the chamber 1. The wafer heater 8 generates heat by being controlled by the controller 9. The wafer heater 8 further measures the temperature of the wafer 10 held by the lift pins 2, and outputs the temperature to the controller 9.

The chamber 1 further includes a non-illustrated exhaust system. The exhaust system exhausts, by being controlled by the controller 9, a gas from the inside of the chamber 1 via an exhaust port formed in the chamber 1. The exhaust system further measures the pressure of the atmosphere in the chamber 1 and outputs the pressure to the controller 9.

The controller 9 is a computer and includes a CPU, a storage device, a removal memory drive, a communication device, an input device, an output device, and an interface, all of which are not illustrated. The CPU controls the storage device, removal memory drive, communication device, input device, output device, and interface by executing a computer program installed in the controller 9. The storage device records the computer program. The storage device further records information used by the CPU. When a recording medium on which a computer program has been recorded is inserted, the removal memory drive is used for installing the computer program into the controller 9. The communication device is used for downloading a computer program from another computer coupled to the controller 9 via a communication network such that the computer program is installed into the controller 9. The input device outputs the information created by a user's operation to the CPU. Examples of the input device include a key board and a mouse. The output device outputs the information created by the CPU such that the information can be recognized by the user. An example of the output device includes a display that displays an image created by the CPU.

The interface outputs, to the CPU, the information created by an external device coupled to the controller 9, and outputs the information created by the CPU to the external device. The external device includes the hydrogen radical generator 3, the filter drive motor 6, the filter heater 7, and the wafer heater 8.

A computer program installed into the controller 9 is formed of a plurality of computer programs by which the controller 9 can realize each of a plurality of functions. The functions include a wafer conveyor unit and an oxide film removal unit.

The wafer conveyor unit controls the filter drive motor 6 such that the filter for capturing tin 5 is arranged at a position sufficiently far away toward the upper side in the vertical direction from the lift pins 2, before the wafer 10 is held by the lift pins 2. The wafer conveyor unit further controls the pin drive device 4 such that the holding portions of the lift pins 2 are arranged at positions sufficiently far away toward the upper side in the vertical direction from the wafer heater 8, before the wafer 10 is held by the lift pins 2.

The wafer conveyor unit controls the pin drive device 4 such that the wafer 10 is arranged sufficiently near to the wafer heater 8 after the wafer 10 has been held by the lift pins 2. The wafer conveyor unit further controls the filter drive motor 6 such that the filter for capturing tin 5 approaches the wafer 10 until the distance between them becomes a predetermined distance after the wafer 10 has been held by the lift pins 2.

The predetermined distance is one within a range of 1 mm to 10 mm.

The wafer conveyor unit controls the filter drive motor 6 such that the filter for capturing tin 5 is arranged sufficiently far away toward the upper side in the vertical direction from the lift pins 2, after the wafer 10 has been irradiated with hydrogen radicals H*. The wafer conveyor unit further controls the pin drive device 4 such that the holding portions of the lift pins 2 are arranged at positions sufficiently far away toward the upper side in the vertical direction from the wafer heater 8, after the wafer 10 has been irradiated with hydrogen radicals.

The oxide film removal unit controls the hydrogen radical generator 3 such that a predetermined amount of hydrogen radicals H* are radiated onto the wafer 10 held by the lift pins 2. That is, the oxide film removal unit controls the exhaust system such that the atmosphere inside the chamber 1 has a predetermined atmospheric pressure, while the wafer 10 is being held by the lift pins 2. The oxide film removal unit controls the hydrogen gas feeder such that a predetermined amount of hydrogen gas H₂ is supplied into the plasma generating chamber 15. The oxide film removal unit controls the magnetron 14 such that a predetermined amount of the microwaves 17 is outputted into the plasma generating chamber 15.

Hydrogen plasmas are generated in the plasma generating chamber 15 by irradiating, with the microwaves 17, the hydrogen gas with which the plasma generating chamber 15 is filled, thereby allowing a plurality of particles to be generated. The particles include charged ions and non-charged hydrogen radicals H*. The ion includes a hydrogen ion H⁺. The ion is captured by the filter for capturing ions 12. The hydrogen radicals H* pass through the filter for capturing ions 12, and discharged into the reflow pretreatment chamber 16 to be radiated onto the wafer 10 held by the lift pins 2.

The oxide film removal unit controls the filter heater 7 such that the temperature of the filter for capturing tin 5 becomes a predetermined temperature, while the wafer 10 is being irradiated with hydrogen radicals H*. The predetermined temperature is one within a range of 50° C. to an allowable temperature limit. The allowable temperature limit represents the maximum temperature that the filter for capturing tin 5 can bear, and the temperature is, for example, 200° C. The oxide film removal unit further controls the filter drive motor 6 such that the filter for capturing tin 5 is rotated around a rotational axis parallel to the vertical direction, while the wafer 10 is being irradiated with hydrogen radicals H*.

The oxide film removal unit further controls the wafer heater 8 such that the solders arranged in the wafer 10 have a predetermined temperature. The predetermined temperature is one within a range of 50° C. to a maximum temperature. The maximum temperature represents one lower than the melting point of the solders, and the temperature is, for example, 200° C.

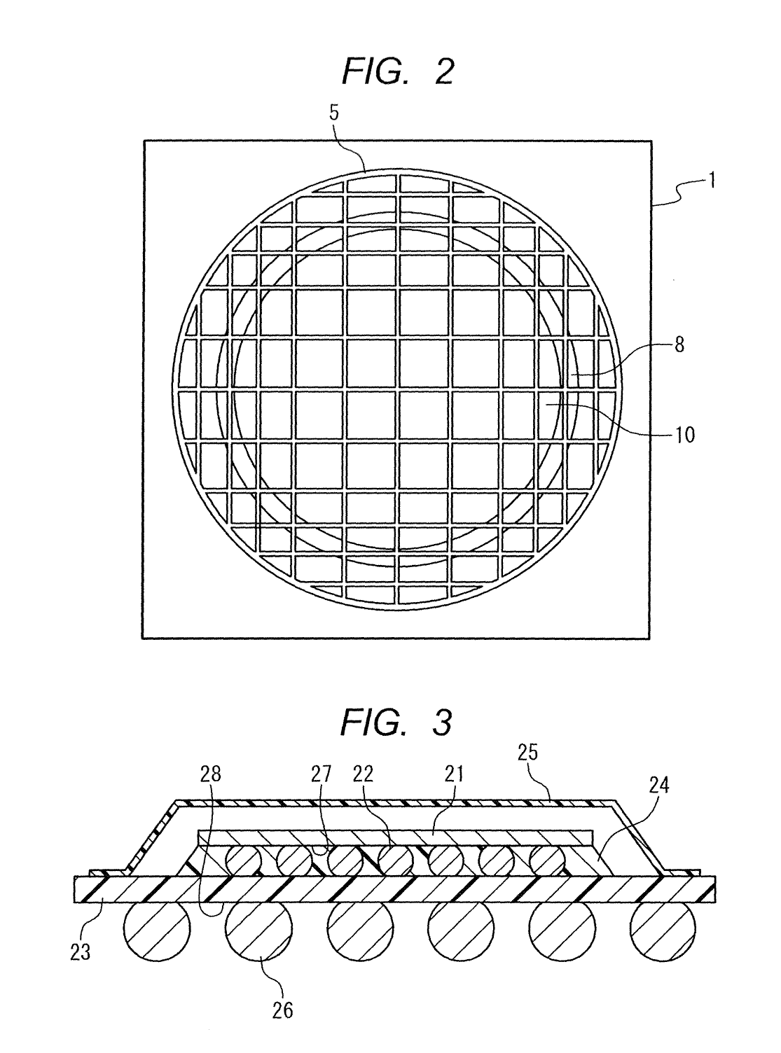

FIG. 2 illustrates the filter for capturing tin 5. The filter for capturing tin 5 is formed into a disk shape one size larger than the wafer 10, and formed into a net shape. The filter for capturing tin 5 is further formed such that the aperture ratio of the area of meshes to that of the filter for capturing tin 5 is approximately 70%. In this case, the hydrogen radicals H* discharged from the hydrogen radical generator 3 into the reflow pretreatment chamber 16 pass through the mesh formed in the filter for capturing tin 5 to be radiated onto the wafer 10. By forming the filter for capturing tin 5 into such a net shape, more hydrogen radicals H* can pass through the filter, and hence more hydrogen radicals H* can be radiated onto the wafer 10 even if the filter is arranged near to the wafer 10. By arranging the filter for capturing tin 5 in the reflow pretreatment chamber 16, tin hydride SnH₄ that is floating in the chamber 16 can be captured. As the surface area of the surface of the filter for capturing tin 5 is larger, the efficiency, as a catalyst for a degradation reaction in which tin hydride SnH₄ is degraded into tin Sn and hydrogen H₂, becomes higher. That is, as the mesh of the filter for capturing tin 5 is finer, tin hydride SnH₄ can be degraded more efficiently, in comparison with the case where the mesh thereof is coarser.

An embodiment of the reflow pretreatment method according to the present invention is performed by using such a reflow pretreatment apparatus, and is applied to a semiconductor package manufacturing method of manufacturing a semiconductor package. The semiconductor package manufacturing method includes an operation for performing the reflow pretreatment method, a reflow treatment, and flip-chip coupling.

In the reflow pretreatment method, the controller 9 first moves, by controlling the filter drive motor 6, the filter for capturing tin 5 to a position sufficiently far away toward the upper side in the vertical direction from the lift pins 2. The controller 9 further arranges, by controlling the pin drive device 4, the holding portions of the lift pins 2 at positions sufficiently far away toward the upper side in the vertical direction from the wafer heater 8. A user places the wafer 10 arranged in the load lock chamber onto the lift pins 2 by opening the gate in the chamber 1 to control the conveyor in the load lock chamber, so that the wafer 10 is held by the lift pins 2. The user closes the gate in the chamber 1 after the wafer 10 has been held by the lift pins 2.

At the time, with the filter for capturing tin 5 being arranged at a position sufficiently far away toward the upper side in the vertical direction from the lift pins 2 and with the holding portions of the lift pins 2 being arranged at positions sufficiently far away toward the upper side in the vertical direction from the wafer heater 8, the wafer can be conveyed from the load lock chamber into the chamber 1 by the conveyor in the load lock chamber without interference by the filter for capturing tin 5 and the wafer heater 8.

The controller 9 moves, by controlling the pin drive device 4 after the wafer 10 has been held by the lift pins 2, the lift pins 2 toward the lower side in the vertical direction such that the wafer 10 is arranged sufficiently near to the wafer heater 8. With the wafer 10 being arranged sufficiently near to the wafer heater 8, the wafer heater 8 can heat the wafer 10.

The controller 9 further moves, by controlling the filter drive motor 6, the filter for capturing tin 5 toward the lower side in the vertical direction such that the filter for capturing tin 5 is arranged at a predetermined distance (1 mm to 10 mm) from the wafer 10, after the wafer 10 has been held by the lift pins 2. The filter for capturing tin 5 can efficiently capture tin hydride SnH₄ discharged from the wafer 10, with the filter for capturing tin 5 approaching the wafer 10 until the distance between them becomes a predetermined distance.

The controller 9 radiates, by controlling the hydrogen radical generator 3, a predetermined amount of hydrogen radicals H* onto the wafer 10 held by the lift pins 2, while the wafer 10 and the filter for capturing tin 5 are being arranged at predetermined positions. That is, the controller 9 makes the atmosphere in the chamber 1 have a predetermined pressure by controlling the exhaust system. The controller 9 supplies a predetermined amount of hydrogen gas H₂ into the plasma generating chamber 15 by controlling the hydrogen gas feeder. The controller 9 outputs, by controlling the magnetron 14, a predetermined amount of the microwaves 17 into the plasma generating chamber 15 such that hydrogen plasmas are generated in the plasma generating chamber 15.

There are sometimes the cases where oxide films are directly formed on the surfaces of the solders arranged in the wafer 10. The oxide film is removed by irradiating the wafer 10 with hydrogen radicals H*. The oxide film includes a tin oxide film. The tin oxide film includes tin oxide SnO₂. When irradiated with hydrogen radicals H*, the tin oxide film is degraded by a reaction represented by the following chemical equation: SnO₂+4H*→Sn+2H₂OSnO₂+8H*→SnH₄+2H₂O, thereby allowing tin Sn and tin hydride SnH₄ to be generated. Tin Sn remains on the surface of the solder. Tin hydride SnH₄ is a gas volatilized after generated, and floats in the reflow pretreatment chamber 16.

The controller 9 further heats, by controlling the wafer heater 8, the solders arranged in the wafer 10 to a predetermined temperature. As the predetermined temperature is higher, an oxide film on the surface of the solder can be removed more efficiently; however, if the temperature exceeds the melting point of the solder, there are sometimes the cases where hydrogen enters the solder, thereby generating a bubble in a bump. Accordingly, it is preferable that the predetermined temperature is 50° C. or higher and the melting point of the solder or lower. When hydrogen radicals H* are radiated onto the solders, the oxides film on the solders can be efficiently degraded and removed by heating the solders to the predetermined temperature.

When brought into contact with the protective film of the wafer 10, tin hydride SnH₄ is dissociated into tin Sn and hydrogen H₂ with the protective film being a catalyst. The dissociated tin Sn adheres to the protective film and accumulates thereon. When the predetermined temperature is high, a dissociation rate, with the protective film of the wafer 10 being a catalyst, becomes large. Accordingly, it is further preferable that the predetermined temperature is 100° C. or higher and 150° C. or lower. Thereby, it becomes possible that the dissociation rate, with the protective film of the wafer 10 being a catalyst, can be suppressed, while the oxide films on the surfaces of the solders are being removed efficiently. When brought into contact with the filter for capturing tin 5, tin hydride SnH₄ is dissociated into tin Sn and hydrogen H₂. The dissociated tin Sn adheres to the filter for capturing tin 5 and is solidified.

The controller 9 heats, by controlling the filter heater 7, the filter for capturing tin 5 to a predetermined temperature, while the wafer 10 is being irradiated with hydrogen radicals H*. The predetermined temperature is one within a range of 50° C. to an allowable temperature limit. The allowable temperature limit represents the maximum temperature that the filter for capturing tin 5 can bear, and the temperature is, for example, 200° C. When heated to the predetermined temperature, the filter for capturing tin 5 can efficiently capture the tin hydride SnH₄ discharged from the wafer 10. It is further preferable that the temperature of the filter for capturing tin 5 is made higher than that of the solders arranged in the wafer 10. Thereby, it becomes possible that the tin hydride SnH₄ is efficiently captured by the filter for capturing tin 5, while the dissociation rate, with the protective film of the wafer 10 being a catalyst, is being suppressed.

The controller 9 further rotates, by controlling the filter drive motor 6, the filter for capturing tin 5 around a rotational axis parallel to the vertical direction, while the wafer 10 is being irradiated with hydrogen radicals H*. Hydrogen radicals H* are uniformly radiated onto the solders in the wafer 10 by rotating the filter for capturing tin 5. The tin hydride SnH₄ discharged from the wafer 10 can be uniformly captured by the filter for capturing tin 5 by rotating the filter for capturing tin 5.

The controller 9 moves, by controlling the filter drive motor 6, the filter for capturing tin 5 to a position sufficiently far away toward the upper side in the vertical direction from the lift pins 2, after the wafer 10 has been irradiated with hydrogen radicals H*. The controller 9 further moves, by controlling the pin drive device 4, the holding portions of the lift pins 2 to positions sufficiently far away toward the upper side in the vertical direction from the wafer heater 8, after the wafer 10 has been irradiated with hydrogen radicals H*. A user conveys, into the load lock chamber, the wafer 10 held by the lift pins 2 by opening the gate in the chamber 1 to control the conveyor in the load lock chamber. With the filter for capturing tin 5 being arranged at a position sufficiently far away toward the upper side in the vertical direction from the lift pins 2 and with the holding portions of the lift pins 2 being arranged at positions sufficiently far away toward the upper side in the vertical direction from the wafer heater 8, the wafer 10 can be conveyed into the load lock chamber by the conveyor in the load lock chamber without interference by the filter for capturing tin 5 and the wafer heater 8.

According to such a reflow pretreatment method, an amount of the tin hydride SnH₄ brought into contact with the protective film of the wafer 10 can be reduced by capturing the tin hydride SnH₄ that floats in the chamber 1 with the filter for capturing tin 5. Accordingly, in such a reflow pretreatment method, an amount of tin Sn generated on the protective film of the wafer 10 can be reduced and an amount of tin Sn accumulating on the protective film thereof can also be reduced.

When tin hydride SnH₄ is brought into contact with the inner wall of the chamber 1, tin Sn dissociated from the tin hydride SnH₄ adheres to the inner wall and accumulates thereon. Accordingly, it is needed to regularly clean the inner wall of the chamber 1. According to such a reflow pretreatment method, an amount of tin hydride SnH₄ that floats in the chamber 1 can be reduced and an amount of tin Sn that adheres to the inner wall of the chamber 1 and accumulates thereon can also be reduced. As a result, the frequency of the cleaning can be reduced in such a reflow pretreatment method, thereby allowing the operation rate of the reflow pretreatment apparatus to be improved.

Tin hydride SnH₄ discharged from the solders arranged in the wafer 10 can be brought into contact with the filter for capturing tin 5 at a higher probability by arranging the filter for capturing tin 5 near to the wafer 10. Accordingly, tin hydride SnH₄ can be efficiently captured by the filter for capturing tin 5 and the tin hydride SnH₄ to be brought into contact with the protective film of the wafer 10 can also be efficiently captured. Accordingly, according to an operation for moving the filter for capturing tin 5 near to the wafer 10, it becomes easier to convey the wafer 10 onto or from the lift pins 2 and tin hydride SnH₄ can be captured more efficiently.

As the temperature of the filter for capturing tin 5 is higher, tin hydride SnH₄ can be degraded, by the filter for capturing tin 5, into tin Sn and hydrogen H₂ more efficiently. Accordingly, according to an operation for heating the filter for capturing tin 5, tin hydride SnH₄ can be degraded, by the filter for capturing tin 5, into tin Sn and hydrogen H₂ more efficiently and it can also be reduced more efficiently that tin hydride SnH₄ may accumulate on the protective film. Further, by heating the filter for capturing tin 5 to a temperature within a range of 100° C. to the allowable temperature limit, tin hydride SnH₄ can be degraded more efficiently and it can be reduced more efficiently that tin hydride SnH₄ may accumulate on the protective film, in comparison with the case where the filter for capturing tin 5 is heated to a temperature within a range of 50° C. to the allowable temperature limit. When the temperature of the filter for capturing tin 5 becomes 140° C. or higher, a degradation reaction in which tin hydride SnH₄ is degraded into tin Sn and hydrogen H₂ is rapidly accelerated. Accordingly, by heating the filter for capturing tin 5 to a temperature within a range of 150° C. to the allowable temperature limit, tin hydride SnH₄ can be degraded more efficiently and it can also be reduced more efficiently that tin Sn may accumulate on the protective film. In this case, it is preferable that the filter for capturing tin 5 is formed of a metal that can bear the temperature of 200° C.

Alternatively, the filter for capturing tin 5 may be formed of another metal that can bear a temperature up to 200° C. A metal that causes an alloying reaction with tin Sn is preferable as the another metal. Examples of the another metal include: an alloy including nickel Ni; copper Cu; and an alloy including copper Cu. A filter for capturing tin formed of the another metal can degrade tin hydride SnH₄ more efficiently in the same way as in the filter for capturing tin 5. Accordingly, it can be reduced more efficiently, by a reflow pretreatment apparatus to which the filter for capturing tin has been applied, that tin Sn may accumulate on the protective film, in the same way as in the reflow pretreatment apparatus to which the filter for capturing tin 5 has been applied.

The wafer 10, which has been conveyed into the load lock chamber after irradiated with hydrogen radicals H*, is conveyed, in a vacuum or inert gas atmosphere, into a reflow treatment apparatus that has been prepared separately. In the reflow treatment apparatus, a user heats the wafer 10 to a temperature higher than or equal to the melting point of the solder, so that the solders are melted. After each of the solders has been melted, the user cools the melted solders naturally such that the solders are solidified into a plurality of solder bump shapes.

FIG. 3 illustrates a semiconductor package product manufactured by the method of manufacturing a semiconductor package product. The semiconductor package products includes a semiconductor chip 21, a plurality of solder bumps 22, an interposer 23, an underfill resin 24, and a lid 25. The semiconductor chip 21 is part of the wafer 10 and formed into a plate shape and provided, in its inside, with a plurality of both circuit elements and wirings. A plurality of circuits are formed by electrically coupling the circuit elements with the wirings. A protective film and the solder bumps 22 are further formed on a surface of the semiconductor chip 21 facing the interposer 23. The protective film covers the circuit elements and the wirings. Each of the solder bumps 22 is electrically coupled to one of the circuit elements via the wirings.

The interposer 23 is formed into a plate shape and provided with a plurality of internal wirings. The internal wirings are arranged inside the interposer 23 so as to be electrically insulated from each other. A surface of the interposer 23 facing the semiconductor chip 21 is coupled to the semiconductor chip 21 via the solder bumps 22. A plurality of solder balls 26 are formed on the other surface of the interposer 23 opposite to the surface facing the semiconductor chip 21. In this case, the solder bumps 22 are electrically coupled, by the internal wirings, to the solder balls 26, respectively.

The underfill resin 24 is formed of an insulator and injected between the semiconductor chip 21 and the interposer 23. The underfill resin 24 is closely adhered to both a protective film 27 formed over the semiconductor chip 21 and the surface of the interposer 23 facing the semiconductor chip 21, thereby the underfill resin 24 protects the solder bumps 22. The lid 25 is formed into a vessel shape. Because all of the edge of the vessel is closely adhered to the interposer 23, the semiconductor chip 21, arranged inside the vessel, can be protected by the lid 25.

In flip-chip coupling in the method of manufacturing a semiconductor package product, a user first cuts the wafer 10 in which the solder bumps have been formed into a plurality of chips. The user attaches each of the chips 21 to the single interposer 23 by using a later resin filling method. That is, the user arranges the chip 21 and the interposer 23 so as to sandwich the solder bumps 22 and solders the two by melting the solder bumps 22. After the semiconductor chip 21 and the interposer 23 have been soldered, the user applies a liquid insulating resin on one side of the semiconductor chip 21 such that the resin permeates, by a capillary phenomenon, a small gap between the semiconductor chip 21 and the interposer 23. After the application and permeation have been repeated the number of times calculated from the size of the semiconductor chip 21, the user cures the insulating resin into the underfill resin 22. After the underfill resin 22 has been formed, the user closely adheres the lid 25 to the interposer 23 to protect the semiconductor chip 21. The solder balls 26 are formed on the other surface of the interposer 23 opposite to the surface facing the semiconductor chip 21.

Such a later resin filling method is publicly-known and details thereof are disclosed in Japanese Unexamined Patent Publication No. 2009-057575. Alternatively, the underfill resin 22 may be injected by another method different from such a later resin filling method. An example of the another method includes a previous resin filling method in which flip-chip coupling is performed after a resin has been applied on joint surfaces of the chip 21 and the interposer 23. Examples of a resin used in the previous resin filling method include a liquid resin and a film resin. A previous resin filling method to which the liquid resin is applied is publicly-known and is disclosed in Japanese Unexamined Patent Publication No. 2003-338525. A previous resin filling method to which the film resin is applied is also publicly-known and is disclosed in Japanese Unexamined Patent Publication No. 2008-311443.

When tin Sn accumulates on the protective film 27, there are sometimes the cases where two solder bumps of the solder bumps 22, which are different from each other, are electrically coupled to each other. When the two solder bumps are electrically coupled, the semiconductor chip product becomes a defective product. In such a method of manufacturing a semiconductor package product to which the reflow pretreatment method according to the present invention has been applied, an amount of tin Sn accumulating on the protective film 27 can be reduced. As a result, in such a method of manufacturing a semiconductor package product, it can be prevented that the solder bumps 22 may be electrically coupled together, thereby allowing the failure rate of the semiconductor package products to be reduced.

When tin Sn accumulates on the protective film 27, there are sometimes the cases where the protective film 27 and the underfill resin 24 are not closely adhered to each other. In such a method of manufacturing a semiconductor package product to which the reflow pretreatment method according to the present invention has been applied, an amount of tin Sn accumulating on the protective film 27 can be reduced. As a result, in such a method of manufacturing a semiconductor package product, the protective film 27 and the underfill resin 24 in the semiconductor chip 21 can be closely adhered to each other more surely, thereby allowing adhesion failure of the underfill resin 24 in the semiconductor package products to be reduced.

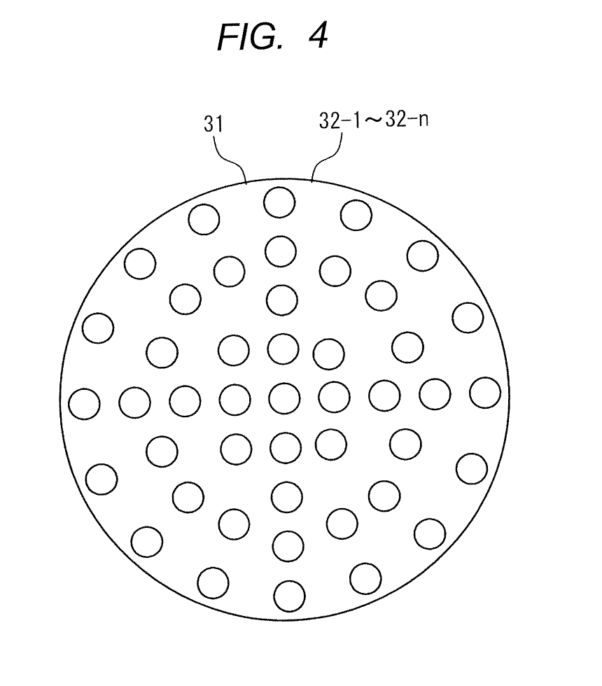

The filter for capturing tin 5 can be replaced by another filter for capturing tin through which a hydrogen radical H* can pass. As illustrated in FIG. 4, for example, the filter for capturing tin 31 is formed into a disk shape one size larger than the wafer 10 in the same way as the filter for capturing tin 5. In the filter for capturing tin 31, a plurality of holes 32-1 to 32-n (n=2, 3, 4, . . . ) are further formed into a so-called punching plate structure. The filter for capturing tin 31 is formed such that the aperture ratio of the area of the holes 32-1 to 32-n to that of the filter for capturing tin 31 is approximately 70%. Sufficiently fine concavities and convexities are further formed on the surface of the filter for capturing tin 31. In this case, hydrogen radicals H* discharged from the hydrogen radical generator 3 into the reflow pretreatment chamber 16 pass through the holes 21-1 to 22-n to be radiated onto the wafer 10.

In the reflow pretreatment apparatus to which the filter for capturing tin 31 has been applied, it can be prevented that tin Sn may accumulate on the protective film of the wafer 10 by capturing tin hydride SnH₄ in the same way as in the reflow pretreatment apparatus to which the filter for capturing tin 5 has been applied.

As the surface area of the surface of the filter for capturing tin 31 is larger, the efficiency, as a catalyst for a degradation reaction in which tin hydride SnH₄ is degraded into tin Sn and hydrogen H_{z}, becomes higher. That is, in the filter for capturing tin 31 on the surface of which concavities and convexities are formed, tin hydride SnH₄ can be captured more efficiently, in comparison with the filter for capturing tin 5. Accordingly, the filter for capturing tin 31 can capture tin hydride SnH₄ more efficiently than the filter for capturing tin 5. Accordingly, in the reflow pretreatment apparatus to which the filter for capturing tin 31 has been applied, it can be prevented that the solder bumps 22 in the semiconductor package formed of the wafer 10 may be electrically coupled to each other or adhesion failure of the resin can be more reduced, by preventing that tin Sn may accumulate on the protective film of the wafer 10, in comparison with the reflow pretreatment apparatus to which the filter for capturing tin 5 has been applied.

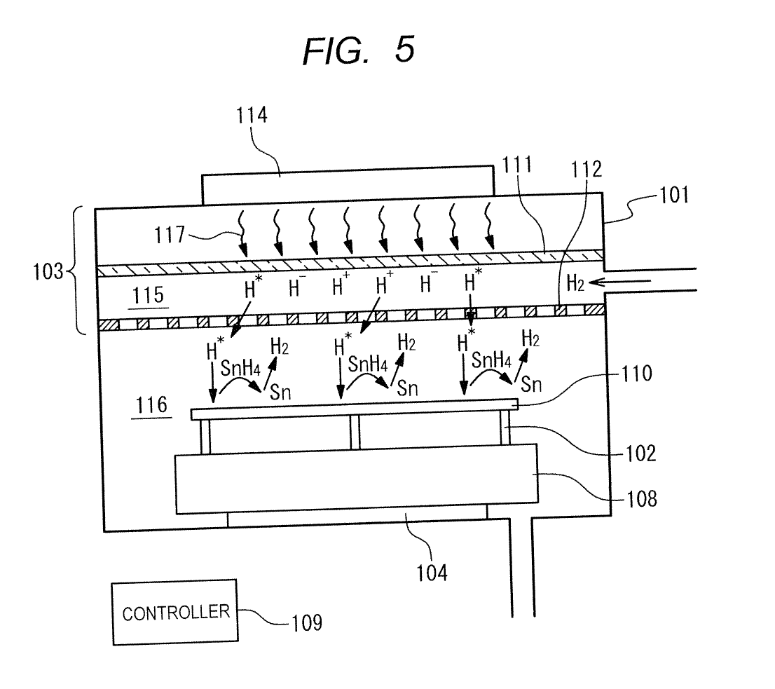

FIG. 5 illustrates a comparative example with respect to the reflow pretreatment apparatus according to the present invention. In the reflow pretreatment apparatus, the filter for capturing tin 5, the filter drive motor 6, and the filter heater 7 are omitted from the reflow pretreatment apparatus according to the invention. That is, the reflow pretreatment apparatus includes a chamber 101, a plurality of lift pins 102, a hydrogen radical generator 103, a pin drive device 104, a wafer heater 108, and a controller 109. The controller 109 is a computer. The chamber 101 is a container for isolating the inside thereof from the outside. The lift pins 102 are arranged inside the chamber 101 to held a wafer 110 inside the chamber 101. A plurality of solders are arranged in the wafer 110 in the same way as in the wafer 10. The pin drive device 104 moves, by being controlled by the controller 109, all of the lift pins 102 in parallel in the vertical direction, while all of the holding portions of the lift pins 102 are being arranged on one horizontal plane.

The hydrogen radical generator 103 includes a quartz plate 111, a filter for capturing ions 112, and a magnetron 114. The quartz plate 111 is formed of quartz and formed into a plate shape. The filter for capturing ions 112 is formed of a conductor and formed into a plate-shaped mesh. The filter for capturing ions 112 is arranged in the chamber 101 such that the inside of the chamber 101 is divided into a plasma generating chamber 115 and a reflow pretreatment chamber 116. The filter for capturing ions 112 is further grounded. A plurality of lift pins 102 are arranged in the reflow pretreatment chamber 116. The magnetron 114 outputs, by being controlled by the controller 109, a microwave 117 into the plasma generating chamber 115 via the quartz plate 111. The hydrogen radical generator 103 further includes a non-illustrated hydrogen gas feeder. The hydrogen gas feeder supplies, by being controlled by the controller 109, hydrogen gas into the plasma generating chamber 115. That is, the hydrogen radical generator 103 radiates, by being controlled by the controller 109, hydrogen radicals H* onto the wafer 110 held by the lift pins 102.

The wafer heater 108 is arranged in the lift pins 102. The wafer heater 108 generates heat by being controlled by the controller 109. The wafer heater 108 further measures the temperature of the wafer 110 held by the lift pins 102, and outputs the temperature to the controller 109.

The chamber 101 further includes an exhaust system. The exhaust system exhausts, by being controlled by the controller 109, a gas from the inside of the chamber 101. The exhaust system further measures the pressure of the atmosphere in the chamber 101 and outputs the pressure to the controller 109.

A comparative example with respect to the reflow pretreatment method according to the present invention is performed by using the reflow pretreatment apparatus according to such a comparative example. A user first makes the lift pins 102 hold the wafer 110. After the wafer 110 has been held by the lift pins 102, the controller 109 moves, by controlling the pin drive device 104, the lift pins 102 toward the lower side in the vertical direction such that the wafer 110 is arranged sufficiently near to the wafer heater 108. The controller 109 further makes, by controlling the exhaust system, the atmosphere in the chamber 101 have a predetermined pressure after the wafer 110 has been held by the lift pins. The controller 109 supplies, by controlling the hydrogen gas feeder, a predetermined amount of hydrogen gas H₂ per unit time into the plasma generating chamber 115. The controller 109 outputs, by controlling the magnetron 114, a predetermined amount of the microwaves 117 into the plasma generating chamber 115. The wafer 110 is irradiated with hydrogen radicals H* by these operations. Oxide films directly formed on the surfaces of a plurality of solders arranged in the wafer 110 are degraded by radiating hydrogen radicals H* onto the wafer 110, so that tin hydride SnH₄ is generated.

The controller 109 heats, by controlling the wafer heater 108, the solders arranged in the wafer 110 to a predetermined temperature, while the wafer 110 is being irradiated with hydrogen radicals H*.

After such a reflow pretreatment method has been performed, a user manufactures, by performing the reflow treatment and flip-chip coupling, a plurality of semiconductor package products from the wafer 110, in the same way as in the method of manufacturing a semiconductor package product according to the aforementioned embodiment.

FIG. 6 shows amounts of Sn accumulating on the surfaces of a plurality of protective films. Of the amounts of Sn accumulating on the surfaces thereof, an amount 41 of Sn accumulating on the surface of a protective film represents an amount of tin Sn accumulating on the protective film of the wafer 110, occurring when the reflow pretreatment method according to the comparative example is performed. Of the amounts of Sn accumulating on the surfaces thereof, an amount 42 of Sn accumulating on the surface of a protective film represents an amount of tin Sn accumulating on the protective film of the wafer 10, occurring when the reflow pretreatment method according to the present invention is performed by using the reflow pretreatment apparatus to which the filter for capturing tin 5 has been applied. Of the amounts of Sn accumulating on the surfaces thereof, an amount 43 of Sn accumulating on the surface of a protective film represents an amount of tin Sn accumulating on the protective film of the wafer 10, occurring when the reflow pretreatment method according to the present invention is performed by using the reflow pretreatment apparatus to which the filter for capturing tin 31 has been applied.

The amounts of Sn accumulating on the surfaces of the protective films show that: the amount 41 of Sn is larger than the amount 42 of Sn and the amount 41 of Sn is also larger than the amount 43 of Sn. That is, the amounts of Sn accumulating on the surfaces of the protective films show that an amount of Sn accumulating on a protective film can be more reduced by the reflow pretreatment method according to the invention, in comparison with the reflow pretreatment method according to the comparative example.

The amounts of Sn accumulating on the surfaces of the protective films show that the amount 43 of Sn is smaller than the amount 42 of Sn. That is, the amounts of Sn accumulating on the surfaces of the protective films show that: an amount of Sn accumulating on the protective film can be more reduced by the reflow pretreatment apparatus to which the filter for capturing tin 31 has been applied, in comparison with the reflow pretreatment apparatus to which the filter for capturing tin 5 has been applied; and the filter for capturing tin 31 can capture tin hydride SnH₄ more efficiently than the filter for capturing tin 5.

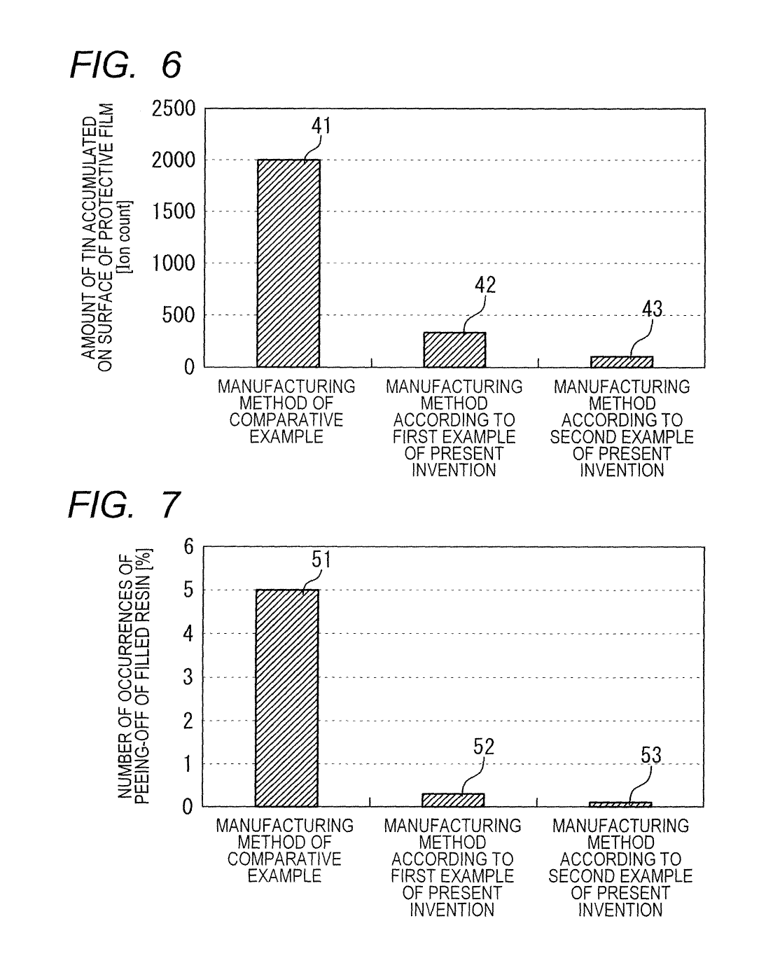

FIG. 7 shows the numbers of occurrences of peeling-off of a plurality of filled resins. Of the numbers of occurrences of peeling-off thereof, the number 51 of occurrences thereof represents the probability that an adhesion failure in which the protective film of the wafer 110 and the resin are not closely adhered to each other, occurring when the reflow pretreatment method according to the comparative example is performed, may occur. Of the numbers of occurrences of peeling-off thereof, the number 52 of occurrences thereof represents the probability that an adhesion failure in which the protective film of the wafer 10 and the resin are not closely adhered to each other, occurring when the reflow pretreatment method according to the present invention is performed by using the reflow pretreatment apparatus to which the filter for capturing tin 5 has been applied, may occur. Of the numbers of occurrences of peeling-off thereof, the number 53 of occurrences thereof represents the probability that an adhesion failure in which the protective film of the wafer 10 and the resin are not closely adhered to each other, occurring when the reflow pretreatment method according to the invention is performed by using the reflow pretreatment apparatus to which the filter for capturing tin 31 has been applied, may occur.

The numbers of occurrences of peeling-off of the filled resins show that: the number 51 of occurrences thereof is larger than the number 52 of occurrences thereof and the number 51 of occurrences thereof is also larger than the number 53 of occurrences thereof. That is, the numbers of occurrences of peeling-off of the filled resins show that the adhesion failure can be prevented more surely by the reflow pretreatment method according to the present invention, in comparison with the reflow pretreatment method according to the comparative example.

The numbers of occurrences of peeling-off of the filled resins show that the number 53 of occurrences thereof is smaller than the number 52 of occurrences thereof. That is, the numbers of occurrences of peeling-off of the filled resins show that: the adhesion failure can be prevented more surely by the reflow pretreatment apparatus to which the filter for capturing tin 31 has been applied, in comparison with the reflow pretreatment apparatus to which the filter for capturing tin 5 has been applied.

The amounts of Sn accumulating on the surfaces of the protective films in FIG. 6 and the numbers of occurrences of peeling-off of the filled resins in FIG. 7 show that: as an amount of Sn accumulating on the protective film is larger, the probability that the adhesion failure may occur becomes larger; i.e., that there is a causal relationship between an amount of Sn accumulating on the protective film and occurrence of the adhesion failure.

Alternatively, in the reflow pretreatment method according to the present invention, the rotation of the filter for capturing tin 5, occurring while hydrogen radicals are being radiated, may be replaced by a move of the wafer 10, occurring while hydrogen radicals are being radiated. Also, in this case, the wafer 10 can be sufficiently and uniformly irradiated with hydrogen radicals in the reflow pretreatment method according to the invention, in the same way as in the aforementioned embodiments.

Alternatively, in the reflow pretreatment method according to the present invention, a move of the filter for capturing tin 5 (or filter for capturing tin 31), occurring when hydrogen radicals are being radiated, may be omitted when the wafer 10 can be sufficiently and uniformly irradiated with hydrogen radicals even without the aforementioned move. Also, in this case, adhesion of tin Sn can be prevented in the reflow pretreatment method according to the invention, in the same way as in the aforementioned embodiments.

Alternatively, an operation for moving the filter for capturing tin 5 (or filter for capturing tin 31) may be omitted in the reflow pretreatment method according to the present invention, and the filter drive motor 6 may be omitted in the reflow R116012 pretreatment apparatus, when the conveyor in the load lock chamber can convey the wafer 10 into or from the lift pins 2 in a state where the filter for capturing tin 5 (or filter for capturing tin 31) is arranged so as to sufficiently capture tin hydride SnH₄.

Alternatively, an operation for moving the lift pins 2 may be omitted in the reflow pretreatment method according to the present invention, and the pin drive device 4 may be omitted in the reflow pretreatment apparatus, when the conveyor in the load lock chamber can convey the wafer 10 into or from the lift pins 2 in the case where the lift pins are arranged at sufficiently low positions in the vertical direction such that the wafer heater 8 can heat the wafer 10.

Alternatively, the filter for capturing tin 5 (or filter for capturing tin 31) may be formed of another material different from Ni. Examples of the material include ceramic and metals. As the metals, a metal that causes an alloying reaction with tin is preferable, and accordingly a metal including nickel or cupper Cu is preferable, in terms that the metal is more resistant to re-discharge of dissociated tin in comparison with ceramic.

Alternatively, an operation for heating the filter for capturing tin 5 (or filter for capturing tin 31) may be omitted in the reflow pretreatment method according to the present invention, and the filter heater 7 may be omitted in the reflow pretreatment apparatus, when tin hydride SnH₄ can be sufficiently captured by the filter for capturing tin 5 even without heating the filter for capturing tin 5.

In the reflow pretreatment apparatus according to the present invention, the distance between the wafer 10 and the filter for capturing tin 5 can be changed. As the distance between the two is smaller, the generated tin hydride SnH₄ can be captured more efficiently while hydrogen radicals H* are being radiated; however, it becomes difficult to convey the wafer 10, which is warped or bent, into or from an area under the filter for capturing tin 5. The risk that the wafer 10 and the filter for capturing tin may interfere with each other or may be in contact with each other, occurring when the wafer 10 is conveyed into or from the area, can be suppressed by making the distance between the two to be large; and tin Sn can be captured efficiently during the radiation by making the distance between the two to be small.

Further, the reflow pretreatment method according to the present invention can be applied to the manufacture of a semiconductor package product different from that illustrated in FIG. 3. Examples of the semiconductor package product include a semiconductor package product in which flip-chip coupling is performed via a Cu pillar bump, and a semiconductor package product in which an underfill resin has been omitted. In the semiconductor package product to which the Cu pillar bump has been applied, a short-circuit failure and an adhesion failure of an underfill resin, occurring due to the adhered tin, can be prevented. In the semiconductor package product in which an underfill resin has been omitted, a short-circuit failure, occurring due to the adhered tin, can be prevented. The Cu pillar bump has a structure in which a cylindrical conductor including Cu is formed over an electrode pad in the wafer 10 and solder is formed over the cylindrical conductor. In the wafer 10 in which the Cu pillar bump has been formed, the risk that the wafer 10 may be in contact with the filter for capturing tin 5, occurring due to a variation in the height of the pillar, etc., when the wafer 10 is conveyed into or from the area under the filter for capturing tin 5 or a radiation position, is large; and if the wafer is in contact with it only slightly, a failure is likely to be caused due to a deformation, etc. Accordingly, the reflow pretreatment apparatus and the reflow pretreatment method according to the invention, in which the distance between the wafer 10 and the filter for capturing tin 5 is particularly changed, are effective for Cu pillar products.

Alternatively, the step of radiating hydrogen radicals H* may include a first step of radiating hydrogen radicals at a distance D1 between the wafer 10 and the filter for capturing tin 5, and a second step of radiating hydrogen radicals at a distance D2 larger than the distance D1. A radiation distribution in the wafer plane by the filter for capturing tin 5 can be made small by particularly performing the second step after the first step, i.e., by radiating hydrogen radicals at D1 (<D2), in which an efficiency of capturing tin is high, in a state where an oxide film on the surface of solder is thick and an amount of generated tin hydride SnH₄ is large, and by radiating hydrogen radicals at D2 after a certain amount of the oxide film has been removed.

Further, the reflow pretreatment method according to the present invention can be applied to the formation of another solder bump that is to be used in an application different from flip-chip coupling. The reflow pretreatment method according to the invention can be applied to, for example, the formation of the solder balls 26 illustrated in FIG. 3. In this case, it can be prevented that tin may be adhered to a surface of the interposer 23 on which the solder balls 26 are formed and a short-circuit failure, in which the solder balls are electrically coupled to each other, can be prevented.

What is claimed is:

1. A method of manufacturing a semiconductor device, comprising the steps of:
arranging both an object to be soldered in which solder including tin has been arranged and a filter for capturing suspended solids at predetermined positions; and
irradiating the solder arranged in the object to be soldered with hydrogen radicals, while the object to be soldered and the filter for capturing suspended solids are being arranged at the predetermined positions,
wherein the hydrogen radicals are radiated onto the solder after passing through the filter for capturing suspended solids, while the object to be soldered and the filter for capturing suspended solids are being arranged at the predetermined positions.

2. The method of manufacturing a semiconductor device according to claim 1, further comprising a step of:
heating the filter for capturing suspended solids to a temperature at which the filter for capturing suspended solids captures a suspended solid, while the solder is being irradiated with the hydrogen radicals.

3. The method of manufacturing a semiconductor device according to claim 2, further comprising a step of:
moving the filter for capturing suspended solids with respect to the object to be soldered, while the solder is being irradiated with the hydrogen radicals.

4. The method of manufacturing a semiconductor device according to claim 3, further comprising a step of:
heating the solder to a temperature at which an oxide film is removed, while the solder is being irradiated with the hydrogen radicals.

5. The method of manufacturing a semiconductor device according to
a plurality of solder bumps by melting and solidifying the solder which has been irradiated with hydrogen radicals.

6. The method of manufacturing a semiconductor device according to claim 5, further comprising a step of:
soldering the object to be soldered and an soldering object via the solder bump,
wherein the object to be soldered includes a plurality of circuits formed over a semiconductor substrate and a plurality of first pads each electrically coupling to each of the terminals of the circuits,
wherein the soldering object includes a plurality of second pads, and
wherein each of the solder bumps electrically couples one of the first pads to one of the second pads.

7. A reflow pretreatment apparatus, comprising:
a hydrogen radical generator for radiating hydrogen radicals onto solder arranged in an object to be soldered; and
a filter for capturing suspended solids,
wherein the filter for capturing suspended solids is arranged such that the hydrogen radicals are radiated onto the solder after passing through the filter for capturing suspended solids.

8. The reflow pretreatment apparatus according to claim 7,
wherein the filter for capturing suspended solids is formed of a metal including nickel or copper.

9. The reflow pretreatment apparatus according to claim 7, further comprising:
a heater for a filter for capturing suspended solids that heats the filter for capturing suspended solids.

10. The reflow pretreatment apparatus according to claim 7, further comprising:
a heater for an object to be soldered that heats the solder.

11. The reflow pretreatment apparatus according to claim 7, further comprising:
an actuator for moving the filter for capturing suspended solids with respect to the object to be soldered.

12. The reflow pretreatment apparatus according to claim 11, further comprising:
a controller for controlling the actuator such that the filter for capturing suspended solids is moved with respect to the object to be soldered while the solder is being irradiated with the hydrogen radicals.
